(19) United States
(12) Patent Application Publication
(10) Pub. No.: US 2008/0091844 A1
(43) Pub. Date: Apr. 17, 2008

(54) HANDOVER METHOD IN DHCPV4, HANDOVER APPARATUS AND MEDIUM HAVING INSTRUCTIONS FOR PERFORMING THE METHOD

(75) Inventor: Soo-hong PARK, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/938,004

(22) Filed: Nov. 9, 2007

Related U.S. Application Data
(63) Continuation of application No. 10/971,029, filed on Oct. 25, 2004.
(60) Provisional application No. 60/513,219, filed on Oct. 23, 2003.

(30) Foreign Application Priority Data
Oct. 27, 2003 (KR) 10-2003-0075239
Oct. 27, 2003 (KR) 2003-75239

(51) Int. Cl. G06F 15/16

(52) U.S. Cl. 709/245

(57) ABSTRACT

A handover apparatus and handover method in a DHCPv4 environment, and a medium having instructions for performing the method, the handover apparatus and method request a DHCP server to acknowledge an IP address lease and receive acknowledgement of the IP address lease as a response to the request.

### CROSS-REFERENCE TO RELATED APPLICATION

This is a continuation application of U.S. application Ser. No. 10/971,029, filed Oct. 25, 2004, which is incorporated herein by reference in its entirety. This application claims priority from U.S. Provisional Application No. 60/513,219 filed on Oct. 23, 2003 in the U.S. Patent and Trademark Office, and Korean Patent Application No. 03-75239 filed on Oct. 27, 2003 in the Korean Intellectual Property Office, the disclosures of which are incorporated herein by reference.

### BACKGROUND OF THE INVENTION

1. Field of the Invention

Apparatuses, media and methods consistent with the present invention relate to a fast handover, and more particularly, to a handover method and handover apparatus in a Dynamic Host Configuration Protocol version 4 (DHCPv4) environment, and a medium comprising executable instructions for performing the handover method.

2. Description of the Related Art

DHCP is a protocol that allows network administrators to centrally manage and assign IP addresses on a network in an organization. DHCPv4 is the DHCP used in an IPv4 address system environment. In using Transmission Control Protocol/Internet Protocol (TCP/IP) protocol on the Internet, each computer should have a proper Internet Protocol (IP) address in order to access the Internet. When computer users in an organization access the Internet, an IP address should be assigned to each computer. In the case where the DHCP is not used, an IP address should be input manually to each computer, and if a computer moves to an area belonging to other part of a network, a new IP address should be input. However, the DHCP enables a network administrator to centrally manage and assign IP addresses, and when a computer accesses to another area of a network, allows a new IP address to be sent automatically.

The DHCP uses the concept of a “lease” which makes a given IP address valid for a computer during a predetermined time. The lease time can vary depending on how long a user is likely to require the Internet connection at a particular location. Even when there are more computers than available IP addresses, the DHCP can dynamically reconfigure networks by using shorter leases of IP addresses.

The address assignment method that is currently used in a wireless Local Area Network (WLAN) and the like is a DHCP, and by using the DHCP, addresses are automatically assigned. Particularly in a WLAN, an access point performs a DHCP server function and assigns addresses to accessing users. Where a user moves between WLANs, in order to maintain the existing connection, an address to be used in the new link should be generated quickly. However, the conventional DHCP operation requires much time. This will now be explained referring to FIG. 1.

FIG. 1 is a diagram to explain a conventional handover operation performed in a DHCP environment. Referring to FIG. 1, a system 100 comprises an access router 110 and access points 120 and 130, and when a mobile node 140 moves, performs a DHCP operation by exchanging messages four times with the access point 130.

Since the system 100 is based on a WLAN, it is shown that an access point performs a DHCP server function, by which an address is automatically assigned to a user requesting an IP address, and a mobile node performs a DHCP client function through which a user requesting an IP address finds a DHCP server and requests an IP address through a defined message. It is understood that a DHCP client function is not limited to a mobile node. While the terms “a mobile node” and “a DHCP client” is used interchangeably below, a mobile node in one aspect refers to a mobile node that performs a DHCP client function. Likewise, an access point in one aspect refers to an access point that performs a DHCP server function.

Referring back to FIG. 1, as the mobile node 140 moves, it transmits a DHCPDISCOVER message 150 requesting an IP address lease to the access point 130 in a multicast manner. All access points receiving this message 150 load leasable IP addresses on respective DHCPOFFER messages 160 to provide an IP address lease, and transmit it to the mobile node 140 (FIG. 1 illustrates the access point 130 receiving and transmitting). The mobile node 140 selects one from the received IP address providing messages 160 and transmits a DHCPREQUEST message 170 to select an IP address lease, to the access point that transmitted the selected message (in FIG. 1, the access point 130). The access point that receives the message 170 provides an IP address lease acknowledgement message, that is, a DHCPACK message 180 indicating that it will lease the selected IP address. Thereafter, the mobile node 140 is able to use the selected IP address.

FIG. 2 shows a DHCP packet format used in a DHCP environment. The DHCP packet 200 includes a 548-byte DHCP message 210. The DHCP message includes a variety of items, such as an operational (OP) code, a hardware type, and the length of a hardware address. In particular, by defining a predetermined function in a 312-byte option field 220, the DHCP message can be made to perform a defined function.

Referring to FIGS. 3 through 7, a conventional fast handover operation performed in a DHCP environment and DHCP messages used in the fast handover operation will be explained in detail. When a user, for example, a mobile node, moves in operation 710, the user broadcasts a request for the location of a DHCP server and IP address information in order to set a new IP address, in operation 720. The broadcasting is made because the user does not have its own IP address yet and know the address of the DHCP server.

This IP address lease request is transmitted in the form of a DHCPDISCOVER message. As shown in FIG. 3, the contents of the DHCPDISCOVER message 150 include a source IP address, a destination IP address, and a hardware address. For example, the source IP address may be 0.0.0.0 because there is no address yet, and the destination IP address may be 255.255.255.255 because the transmission is a broadcast. The hardware address may be its own media access control (MAC) address.

In operation 730, a DHCP server (where there are a plurality of DHCP servers, each of the DHCP servers may receive the message), which is requested to lease an IP address, responds to the DHCPDISCOVER message by transmitting a DHCPOFFER message. As shown in FIG. 4, the contents of the DHCPOFFER message 160 include a source IP address which is the IP address of the DHCP server, a destination IP address to be broadcasted because an IP address is not assigned yet, an offered IP address indicating an IP address leasable to the client, a client hardware address which is the MAC address informed by the client, a subnet mask of the leasable IP, the lease period of the leasable IP, and a server identifier indicating the IP address of the DHCP server. This message is also a broadcast because an IP address is not assigned yet to the client. The DHCP client selects a message that arrives first among DHCPOFFER messages transmitted by servers.

In operation 740, after selecting the message that arrived first among the received DHCPOFFER messages, the DHCP client responds to the corresponding DHCP server with a DHCPREQUEST message. A broadcast is also used in this case so as to inform all DHCP servers and prevent duplicated assignment of IP addresses. As shown in FIG. 5, the DHCPREQUEST message 170 includes a source IP address, a destination IP address, a hardware address which is the MAC address of the DHCP client, a requested IP address which is the IP address selected by the DHCP client, and a server identifier which is the IP address of the server offering to lease this IP address. Here, the source IP address may be set to 0.0.0.0 because the IP address of the client is not determined yet, and the destination IP address may be 255.255.255.255 to broadcast to all other DHCP servers that only one IP address is selected.

In operation 750, the DHCP server receiving the DHCPREQULEST message broadcasts an acknowledgement response in the form of a DHCPACK message to the client. Only the DHCP server which offered the IP address selected by the client transmits this DHCPACK message, and the remaining DHCP servers keep IP addresses to be leased by other DHCP clients knowing that their lease offers were not selected. As shown in FIG. 6, the DHCPACK message 180 includes a source IP address which is the IP address of the DHCP server, a destination IP address, an offered IP address which is the IP address to be leased, a client hardware address which is the MAC address of the client, a subnet mask of the IP address to be leased, and the lease period. The destination address may be 255.255.255.255 to broadcast because the IP address may not be regarded as valid until the client receives the DHCPACK message.

In operation 760, where the DHCP client receives the acknowledgement response, a TCP/IP is initialized and the DHCP client is treated as a bound DHCP client. After the binding, the DHCP client may transmit and receive data using the TCP/IP.

As described above, the conventional DHCP operation exchanges messages four times. That is, a user who desires to be assigned an IP address broadcasts a DHCPDISCOVER message, receives DHCPOFFER messages from available DHCP servers, selects a desired one among the DHCP servers, transmits another message DHCPREQULEST, waits for a response, and then receives a DHCPACK message. Accordingly, the conventional DHCP operation necessarily requires a long period of time. A period of time where the user is without an assigned IP address is also long during the DHCP operation.

### SUMMARY OF THE INVENTION

A handover apparatus, handover method and a medium having instructions for performing the method are provided, wherein in the case of a handover performed in a DHCPv4 environment, time taken for assigning an IP address is reduced and an established connection is reliably maintained.

According to an exemplary embodiment of the present invention, there is provided a handover method in a DHCPv4 environment, the method comprising requesting a DHCP server to acknowledge IP address lease, and receiving an IP address lease acknowledgement from the DHCP server as a response to the request. The IP address lease acknowledgement may comprise an offered IP address.

The requesting may comprise transmitting an IP address lease request comprising a fast response identifier requesting the IP address lease acknowledgement. The IP address lease request may be a DHCP message and the fast response identifier may be recorded in an option field thereof The IP address lease acknowledgement may comprise the fast response identifier. The IP address lease request may be a DHCPDISCOVER message and the IP address lease acknowledgement may be a DHCPACK message.

According to an exemplary embodiment of the present invention, there is provided a handover method for a client in a DHCPv4 environment, the method comprising outputting a message receivable by servers requesting an IP address lease acknowledgement as a response to the message. Each IP address lease acknowledgement may comprise an offered IP address.

The method may further comprise maintaining a connection with a node corresponding to the client by utilizing an offered IP address of an IP address lease acknowledgement being received first.

The message may comprise a code in an optional field thereof requesting the IP address lease acknowledgement comprising an offered IP address. The outputting of the message may comprise broadcasting the message.

According to an exemplary embodiment of the present invention, there is provided another handover method in a DHCPv4 environment, the method comprising receiving a request from a DHCP client to acknowledge an IP address lease, and transmitting an IP address lease acknowledgement to the DHCP client in response to the request. The IP address lease acknowledgement may comprise an offered IP address.

The receiving of the request may comprise receiving an IP address lease request comprising a fast response identifier requesting the IP address lease acknowledgement. The IP address lease acknowledgement comprises the fast response identifier.

According to an exemplary embodiment of the present invention, there is provided a handover method for a server in a DHCPv4 environment, the method comprising outputting an IP address lease acknowledgement in response to a request from a client to acknowledge an IP address lease.

The outputting of the IP address lease acknowledgement may comprise outputting the IP address lease acknowledgement comprising an offered IP address. The outputting of the IP address lease acknowledgement may comprise broadcasting the IP address lease acknowledgement. The IP address lease acknowledgement may further comprises a code in an optional field thereof corresponding to the request for the IP address lease acknowledgement.

According to an exemplary embodiment of the present invention, there is provided a handover apparatus for use in a client in a DHCPv4 environment, comprising a message generation unit which generates an IP address lease request comprising a fast response identifier requesting an IP address lease acknowledgement as a response to the request, and a message interpretation unit which receives the IP address lease acknowledgement. The IP address lease acknowledgement may comprise an offered IP address. The message interpretation unit may obtain an IP address for use by interpreting the IP address lease acknowledgement message.

The IP address lease request may be a message receivable by servers, each IP address lease acknowledgement may comprise an offered IP address, and the message interpretation unit may interpret an IP address lease acknowledgement message being received first to obtain a corresponding offered IP address as an IP address for use.

According to an exemplary embodiment of the present invention, there is provided another handover apparatus for use in a client in a DHCPv4 environment, comprising means for requesting a DHCP server to acknowledge an IP address lease and means for receiving an IP address lease acknowledgement from the DHCP server as a response to the request.

According to an exemplary embodiment of the present invention, there is provided a handover apparatus used in a server in a DHCPv4 environment, comprising a message interpretation unit which determines whether a fast response identifier requesting an IP lease acknowledgement as a response, is included in a received IP address lease request, and a message generation unit which generates the IP address lease acknowledgement where the fast response identifier is included in the IP address lease request. The IP address lease acknowledgement may comprise an offered IP address.

The apparatus may further comprise a leasable IP address storing unit which stores a plurality of IP addresses, and an IP address selection unit which selects an IP address from the leasable IP address storing unit where the fast response identifier is included in the IP address lease request, wherein the message generation unit records the IP address as the offered IP address in the IP address lease acknowledgement.

According to an exemplary embodiment of the present invention, there is provided another handover apparatus used in a server in a DHCPv4 environment, comprising means for receiving a request from a DHCP client to acknowledge an IP address lease and means for transmitting an IP address lease acknowledgement to the DHCP client in response to the request.

According to an exemplary embodiment of the present invention, for each of the methods of the present invention, there is provided a computer-readable medium comprising computer-executable instructions for performing the method.

According to an exemplary embodiment of the present invention, there is provided a method in a computer system for a client to implement a handoff in a DHCPv4 environment, the method comprising controlling a message generation unit to generate an IP address lease request requesting an IP address lease acknowledgement as a response to the request, and controlling a message interpretation unit to extract an IP address for use by interpreting the IP address lease acknowledgement.

According to an exemplary embodiment of the present invention, there is provided a method in a computer system for a server to implement a handoff in a DHCPv4 environment, the method comprising controlling a message interpretation unit to interpret a received IP address lease request to determine whether an IP address lease acknowledgement is requested as a response to the request, and controlling a message generation unit to generate the IP address lease acknowledgement comprising an offered IP address where the IP address lease acknowledgement is requested as the response.

### BRIEF DESCRIPTION OF THE DRAWINGS

The aspects and advantages of the invention will become apparent and more readily appreciated from the following description of the exemplary embodiments of the present invention, taken in conjunction with the accompanying drawings of which:

FIG. 1 is a system diagram to explain a conventional handover method performed in a DHCP environment;

FIG. 2 is a block diagram illustrating a DHCP packet format used in the DHCP environment;

FIG. 3 is a block diagram illustrating the structure of a DHCPDISCOVER message used in the DHCP environment;

FIG. 4 is a block diagram illustrating the structure of a DHCPOFFER message used in the DHCP environment;

FIG. 5 is a block diagram illustrating the structure of a DHCPREQUEST message used in the DHCP environment;

FIG. 6 is a block diagram illustrating the structure of a DHCPACK message used in the DHCP environment;

FIG. 7 is a flowchart illustrating operations of the conventional handover method in the DHCP environment;

FIG. 8 is a system diagram to explain a handover method performed in a DHCP environment according to an exemplary embodiment of the present invention;

FIG. 9 is a block diagram illustrating the structure of a DHCPDISCOVER message used in the DHCP environment according to an exemplary embodiment of the present invention;

FIG. 10 is a block diagram illustrating the structure of DHCPACK message used in the DHCP environment according to an exemplary embodiment of the present invention;

FIG. 11 is a flowchart illustrating operations of a handover method in a DHCP environment according to an exemplary embodiment of the present invention;

FIG. 12 is a schematic block diagram of an apparatus which performs a handover in a DHCP environment for use in a DHCP client, according to an exemplary embodiment of the present invention; and

FIG. 13 is a schematic block diagram of an apparatus which performs a handover in a DHCP environment for use in a DHCP server, according to an exemplary embodiment of the present invention.

### DETAILED DESCRIPTION OF THE INVENTION

Reference will now be made in detail to the exemplary embodiments of the present invention, examples of which are illustrated in the accompanying drawings, wherein like reference numerals refer to like elements throughout. The exemplary embodiments are described below in order to explain the present invention by referring to the figures.

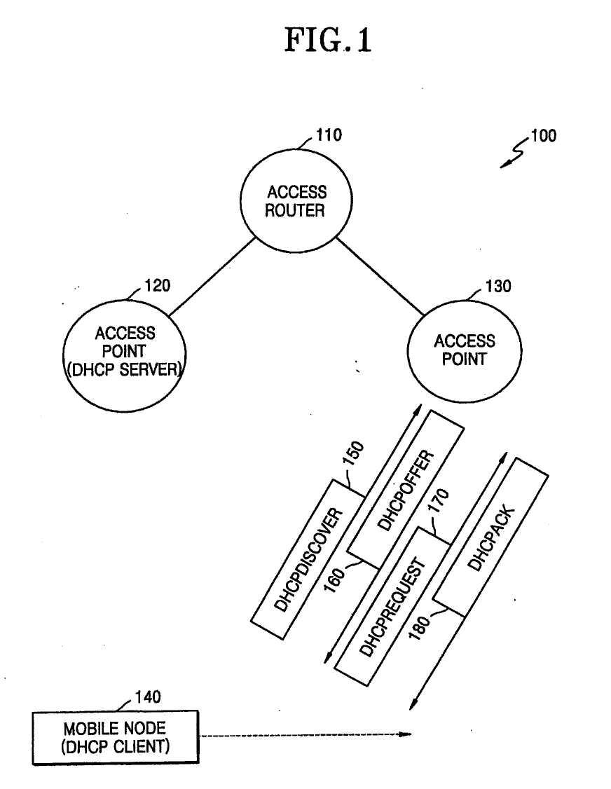

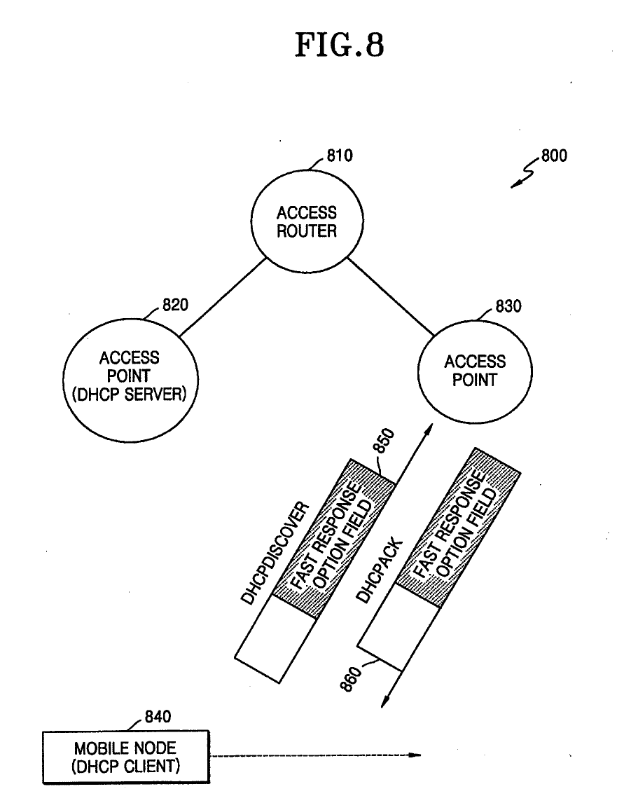

FIG. 8 shows a system to explain a handover operation performed in a DHCPv4 environment according to an exemplary embodiment of the present invention. The system 800 comprises an access router 810, and access points 820 and 830. As compared to the conventional DHCP operation described above with reference to FIG. 1, in which where a mobile node moves, four messages (DHCPDISCOVER, DHCPOFFER, DHCPREQUEST, DHCPACK) are exchanged in order to obtain a new IP address, in the present exemplary embodiment, where a mobile node 840 moves, an IP address is obtained by exchanging two messages (DHCPDISCOVER, DHCPACK).

That is, the mobile node 840 transmits a DHCPDISCOVER message 850 requesting a fast acknowledgement of an IP address lease, and the access point 830 which receives this message, transmits an IP address lease acknowledgement message, that is, a DHCPACK message 860 to the mobile node 840 directly, without sending an IP address lease offer message. Accordingly, messages, that is, transmitting an IP address lease offer message and an IP address lease selection message may be omitted.

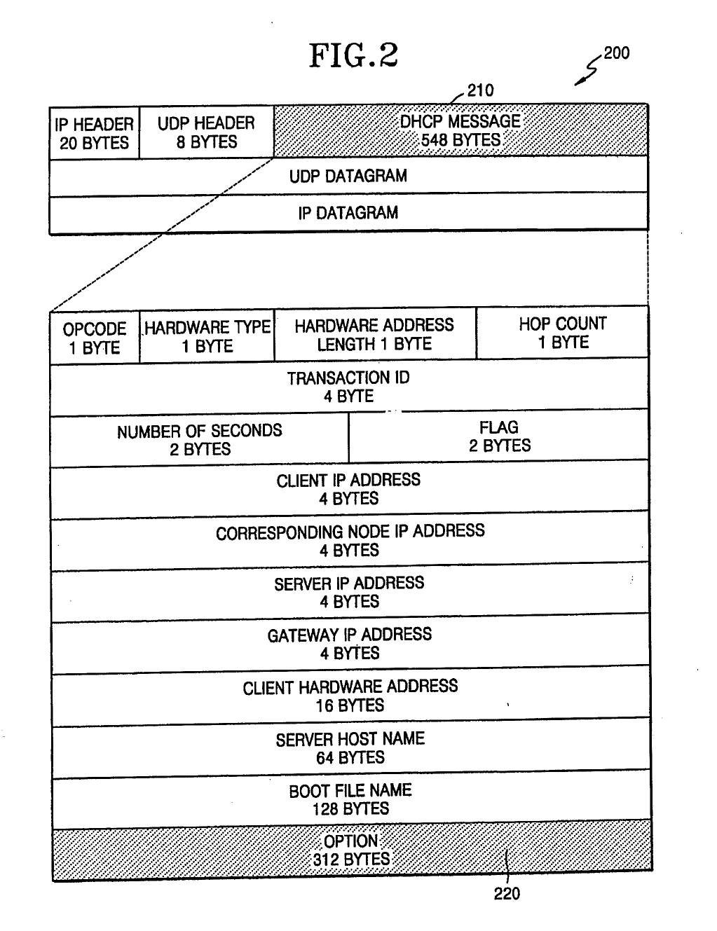

For example, this omission is achieved by requesting a fast response by using the option field 220 of the DHCP message 200 shown in FIG. 2 where a mobile node transmits an IP address lease request message. That is, as shown in FIG. 8, a fast response option field is included in an IP address request message, that is, the DHCPDISCOVER message 850, which is transmitted by the mobile node 840 to the access point 830.

Where the access point 830 confirms that a fast response option field is included in the IP address lease request message, the access point 830 selects a leasable IP address and transmits an IP address lease acknowledgement message, that is, the DHCPACK message 860, comprising the selected IP address and a fast response option field to the mobile node 840. Accordingly, the mobile node 840 is able to use the IP address from the just received IP address lease acknowledgement message. As the mobile node 840 broadcasts the IP address lease request message, all access points receiving the message may send corresponding IP address lease acknowledgement messages. The mobile node 840 may select, for example, an IP address lease acknowledgement message that is received first by the mobile node 840.

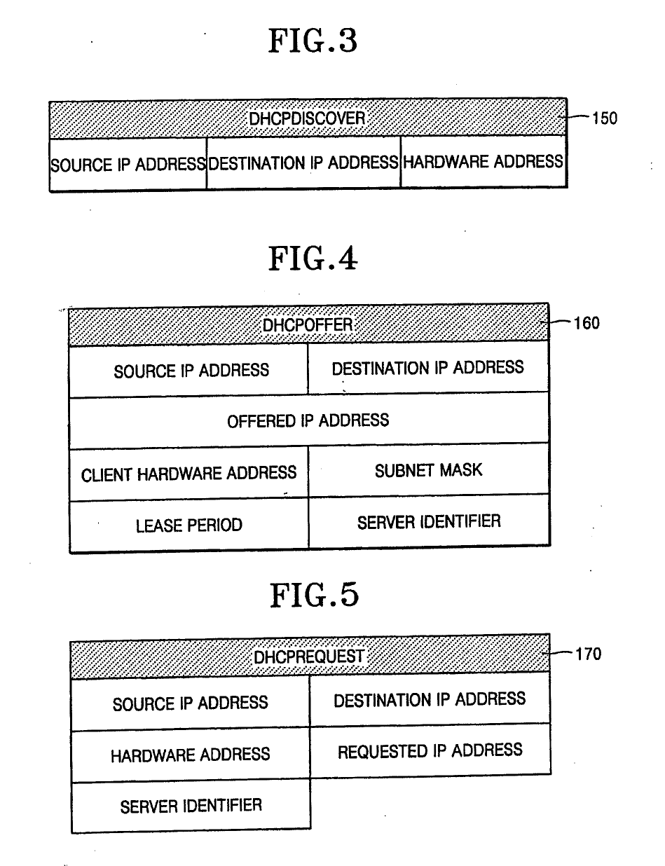

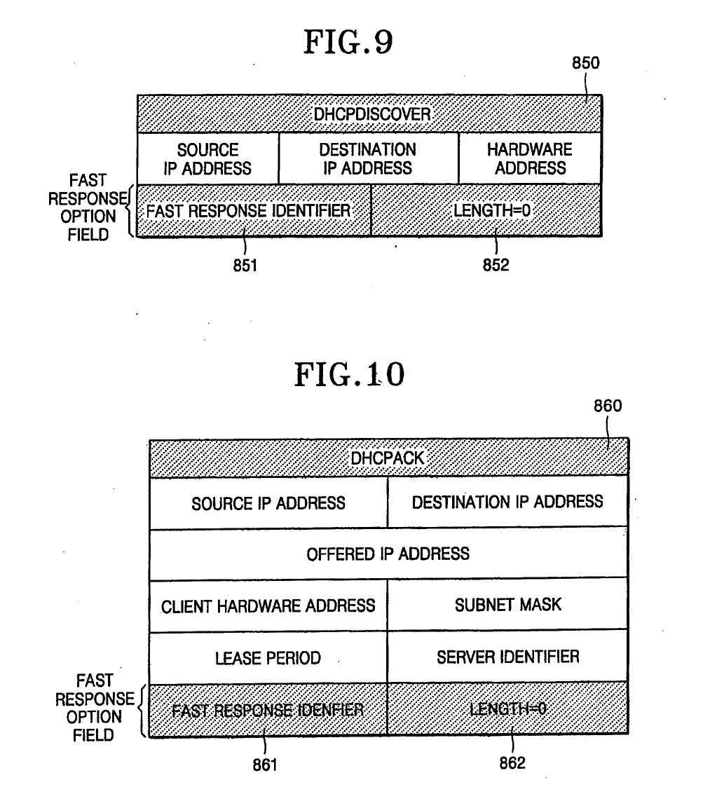

FIG. 9 illustrates a structure of the IP address lease request message 850 comprising a fast response option field, according to the present invention. The structure is the same as that of the IP address lease request message shown in FIG. 3 except that, for example, a fast response identifier 851 is inserted by using the option field. That is, the fast response option field comprises the fast response identifier 851 and a length 852. The fast response identifier 851 is a code indicating that a fast IP address lease acknowledgment is requested. Since this fast response option does not need a data field, the length 852 is set to 0.

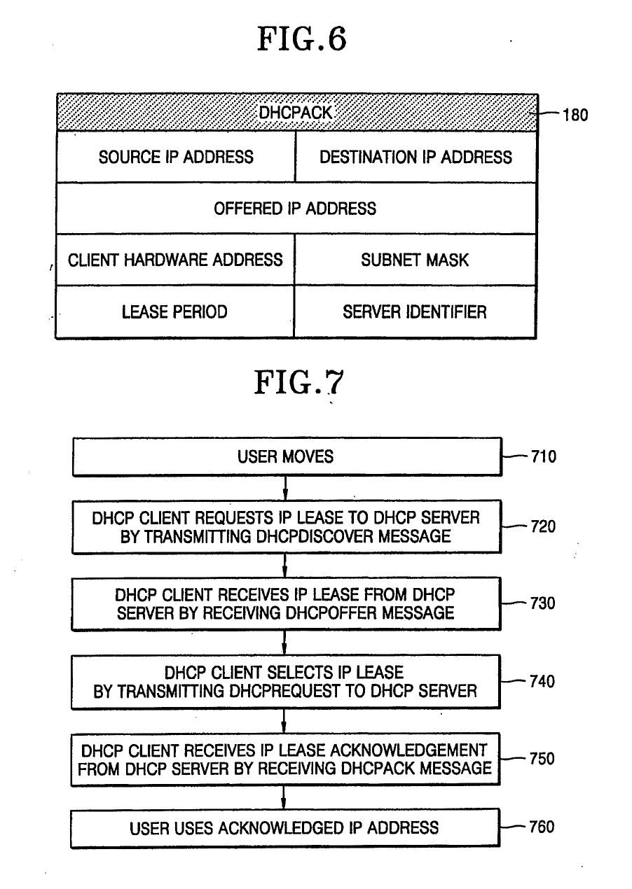

FIG. 10 illustrates a structure of the IP address lease acknowledgement message 860 comprising a fast response option field, according to the present invention. The structure is the same as that of the IP address lease acknowledgement message shown in FIG. 6 except that, for example, a fast response identifier 861 is inserted by using the option field. That is, the fast response option field included in the IP address lease acknowledgement message comprises the fast response identifier 861 and a length 862, as in the fast response option field included in the IP address lease request message of FIG. 9. The fast response identifier 861 is included to indicate, for example, that the IP address lease acknowledgement message corresponds to the response requested by the fast response identifier 851 of the IP address lease request message. Accordingly, an access point having a server function may indicate and output an acknowledgement comprising an offered IP address corresponding to a request having a fast response identifier.

According to an aspect of the exemplary embodiment, while the “offered IP address” field included in the IP address lease acknowledgement message 180 shown in FIG. 6 is selected by a DHCP client, an “offered IP address” field of the IP address lease acknowledgement message 860 is a lease IP address arbitrarily selected by a DHCP server from available IP address/addresses.

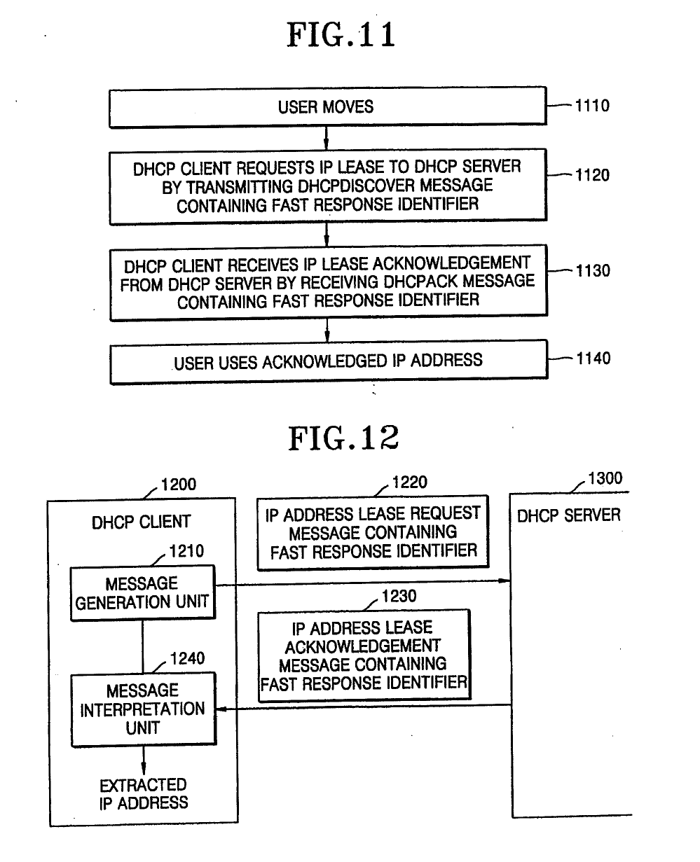

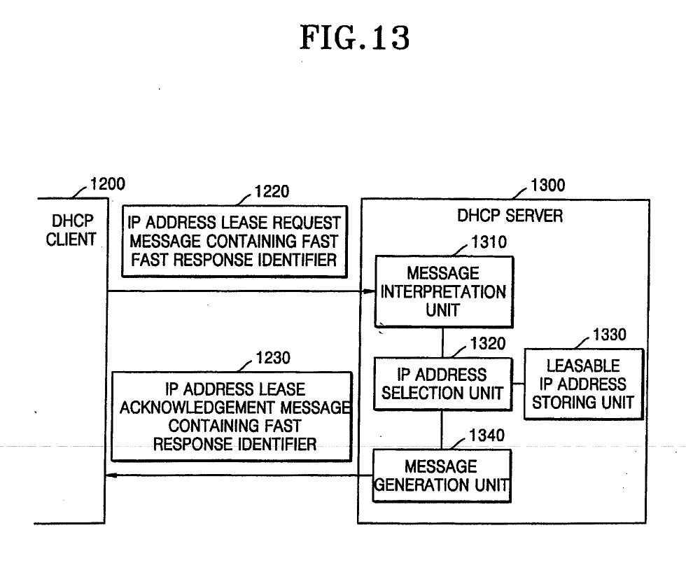

FIG. 11 shows a flowchart illustrating operations of a fast handover method in a DHCPv4 environment according to an exemplary embodiment of the present invention. FIG. 12 illustrates an apparatus which performs a fast handover in a DHCPv4 environment for use in a DHCP client, according to an exemplary embodiment of the present invention. FIG. 13 illustrates an apparatus which performs a fast handover in a DHCPv4 environment for use in a DHCP server, according to an exemplary embodiment of the present invention.

Referring to FIG. 12, a handover apparatus 1200 used in a DHCP client comprises a message generation unit 1210 and a message interpretation unit 1240. By inserting a fast response identifier which is separately prepared to get a fast acknowledgement on an IP address lease, that is, a fast response identifier indicating that a fast IP address lease acknowledgement is requested, into an option field of an IP address lease request message, the message generation unit 1210 generates an IP address lease request message 1220. The message interpretation unit 1240 receives an IP address lease acknowledgement message 1230 from a DHCP server, interprets whether a fast response identifier is included in an option field thereof, and extracts an IP address from the IP address lease acknowledgement message 1230.

Referring to FIG. 13, a handover apparatus 1300 used in a DHCP server comprises a message interpretation unit 1310, an IP address selection unit 1320, a leasable IP address storing unit 1330, and a message generation unit 1340. The message interpretation unit 1310 interprets whether a fast response identifier is included in an option field of an IP address lease request message received from a DHCP client. Where the fast response identifier is included in the received IP address lease request message, the IP address selection unit 1320 selects an IP address from the leasable IP address storing unit 1330, and the message generation unit 1340 records the selected IP address in an IP address lease acknowledgement message and inserts the fast response identifier in an option field of the IP address lease acknowledgement message to generates an IP address lease acknowledgement message 1230.

Referring to FIG. 11, a handover method performed by the handover apparatus of the DHCP client and that of the DHCP server as described above, will be described in detail.

Where a user moves in operation 1110, the message generation unit of the DHCP client generates a DHCPDISCOVER message comprising a fast response identifier and transmits it to the DHCP server to request an IP address lease in operation 1120.

Where the message interpretation unit 1310 of the DHCP server receiving the IP address lease request message 1220 confirms that a fast response identifier is included in an option field of the message 1220, by interpreting the IP address lease request message 1220 from the DHCP client, the IP address selection unit 1320 of the DHCP server selects an IP address from the leasable IP address storing unit 1330. Thereafter, the message generation unit 1340 of the DHCP server records the selected IP address in an IP address lease acknowledgement message, inserts the fast response identifier in an option field of the IP address lease acknowledgement message, and transmits the resulting IP address acknowledgement message 1230 to the DHCP client. By doing so, an IP address lease to the DHCP client is acknowledged in operation 1130.

The message interpretation unit 1240 of the DHCP client receives the IP address lease acknowledgement message 1230, interprets whether the fast response identifier is included in an option field of the IP address lease acknowledgement message 1230, extracts an IP address from the IP address lease acknowledgement message 1230, and uses the acknowledged IP address in operation 1140.

Accordingly, a handover operation in, for example, a DHCPv4 environment, may be completed by exchanging two messages, reducing time taken for assigning an IP address and maintaining a reliable established connection.

While the present invention is described with respect to a WLAN, that is, wireless applications, it is understood that the present invention is not limited thereto and may be applied a variety of other wired and wireless applications, which will be appreciated by those skilled in the art in light of the present invention. As an illustration, the present invention may be applied with respect to a mobile node moving from an area of one access point to an area of another access point, to reduce the time to acquire a new IP address lease while maintaining a reliable connection with a correspondence node that may or may not be stationary. As another illustration, the present invention may be applied with respect to a plurality of clients requiring respective IP addresses from a given server, that is, in a case where a fast acknowledgement is desired where multiple IP lease is required. It is understood that a server may refer to an access point having a server function or a server which is not an access point.

It is understood that a system which uses the present invention also includes permanent or removable storage, such as magnetic and optical discs, RAM, ROM, a carrier wave medium, etc., on which the process and data structures of the present invention can be stored and distributed. The operations can also be distributed via, for example, downloading over a network such as the Internet.

It is also understood that while illustrative, non-limiting embodiments of the present invention overcome the above disadvantages and other disadvantages not described above, the present invention is not required to overcome the disadvantages described above, and illustrative, non-limiting embodiments of the present invention may not overcome any of the problems described above.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A handover method in a Dynamic Host Configuration Protocol (DHCP) environment, the method comprising:
requesting a DHCP server to acknowledge an Internet Protocol (IP) address lease; and
receiving an IP address lease acknowledgement from the DHCP server as a response to the request.

2. The method according to claim 1, wherein the IP address lease acknowledgement comprises an offered IP address.

3. The method according to claim 1, wherein the requesting comprises transmitting an IP address lease request comprising a fast response identifier requesting the IP address lease acknowledgement.

4. The method according to claim 3, wherein the IP address lease acknowledgement comprises the fast response identifier.

5. The method according to claim 3, wherein the IP address lease request is a DHCPDISCOVER message and the IP address lease acknowledgement is a DHCPACK message.

6. The method according to claim 3, wherein the IP address lease request is a DHCP message and the fast response identifier is recorded in an option field of the DHCP message.

7. A handover apparatus for use in a client in a Dynamic Host Configuration Protocol (DHCP) environment, comprising:
a message generation unit which generates an Internet Protocol (IP) address lease request comprising a fast response identifier requesting an IP address lease acknowledgement as a response to the request; and
a message interpretation unit which receives the IP address lease acknowledgement.

8. The apparatus according to claim 7, wherein the IP address lease acknowledgement comprises an offered IP address.

9. The apparatus according to claim 7, wherein:
the IP address lease request is a message receivable by servers,
the IP address lease acknowledgement comprises an offered IP address, and
the message interpretation unit interprets an IP address lease acknowledgement message which is received first to obtain a corresponding offered IP address as an IP address for use.

10. The apparatus according to claim 7, wherein the message interpretation unit obtains an IP address for use by interpreting the IP address lease acknowledgement message.
